(19) United States
(12) Patent Application Publication
(10) Pub. No.: US 2022/0256674 A1
(43) Pub. Date: Aug. 11, 2022

(54) Automatic Lighting System and Control Method

(71) Applicants: Wanjiong Lin, Ningbo (CN); Self Electronics Co., Ltd., Ningbo (CN); Self Electronics USA Corporation, Norcross, GA (US)

(72) Inventors: Huimin Zou, Ningbo (CN); Binjie Xu, Ningbo (CN); Jian Zhang, Ningbo (CN)

(21) Appl. No.: 17/650,383

(22) Filed: Feb. 9, 2022

(30) Foreign Application Priority Data
Feb. 9, 2021 (CN) 202110177174.5

(51) Int. Cl. H05B 47/115; H05B 47/175

(52) U.S. Cl. CPC H05B 47/115; H05B 47/175

(57) ABSTRACT

An automatic lighting system has at least two sets of sensing lighting devices, which include a light source module, a control module, a communication module, and a sensing module, all communication modules are configured to the same communication network; According to the respective sensing module or the signal in the communication network, the control module controls the brightness of the light source modules; the automatic lighting system has a plurality of sensor lighting devices, which can be increased and decreased according to need, and its use and arrangement is very flexible. There is no need for the overall design and layout of the lighting system, and the synchronization between each set of lighting devices is high so that sudden brightening or dimming are avoided.

### CROSS REFERENCE TO RELATED APPLICATION

This application claims priority to a Chinese Patent Application No. CN 202110177174.5, filed on Feb. 9, 2021.

### FIELD OF THE TECHNOLOGY

The present invention relates to the field of lighting control technologies, particularly on an automatic lighting system and a control method.

### BACKGROUND

In order to improve the quality of life, save energy and prolong the service life of lighting equipment, more and more intelligent sensing equipment has been applied to lighting system, existing technology already exists to control lighting systems by placing sensors that sense the presence and movement of people or objects.

At present, sensor detection of moving people or objects is mostly used independently. However, in a network when multiple sensors exist simultaneously and control different lights in the same area, desynchronization phenomenon and DISCO phenomenon can arise between multiple lights.

### BRIEF SUMMARY THE TECHNOLOGY

In view of this, the present invention provides an automatic lighting system and a control method to solve the above technical problems.

An automatic lighting system includes at least two sets of sensing lighting devices, which comprises light source module, control module, communication module and sensor module, all communication modules are configured to the same communication network; and the control module controls the brightness of the respective light source module according to signals in the respective sensing module or communication network.

advantageously, the communication module uses Bluetooth.

advantageously, the sensor module is a microwave sensor.

advantageously, the sensing lighting devices are installed in the same illumination area.

An automatic lighting control method adopting an automatic lighting system mentioned above includes the following steps:

001. The sensor module detects whether someone or something is within the detection range, if there is an effective signal, the control module of the same device receives the effective signal and sends the effective signal to the communication network through the communication module, and controls the light source module of the same device according to the effective signal to maintain the first brightness;

002. The control module obtains an effective signal from the communication network (200) through the communication module of the same device, and controls the light source module of the same device to maintain the first brightness;

003. When the control module determines that there is no effective signal at present, the light source module that controls the same device is maintained at a second brightness less than the first brightness.

advantageously, in step 001, the control module controls the light source module of the same device to maintain at the first brightness according to the effective signal delay of 30 ms˜100 ms.

advantageously, a detection period of the sensor module in step 001 is 5 s to 20 s.

advantageously, in step 003, the control module determines that there is no current effective signal under the following condition: the control module has not received an effective signal after 20 s to 50 s.

The technical effects of the present invention:

The automatic lighting system of the present invention is provided with a plurality of sensor lighting devices, which can be increased and decreased according to the need, and its use and arrangement is very flexible. There is no need for the overall design and layout of the lighting system, and the synchronization between each set of lighting devices is high, it will not appear suddenly bright or dark situation, as a whole, it is easy to use and lighting effect is good.

### BRIEF DESCRIPTION OF THE DRAWINGS

Embodiments of the present invention will be described below with reference to the drawings, in which:

FIG. 1 is a structural wireframe diagram of the automatic lighting system of the present embodiment.

FIG. 2 is an example of a flow diagram of the automatic lighting control method of the present embodiment.

### DETAILED DESCRIPTION OF THE INVENTION

Specific embodiments of the present invention will be described in further detail below based on the drawings. It should be understood that the description of the embodiments of the present invention herein is not intended to limit the protection scope of the present invention.

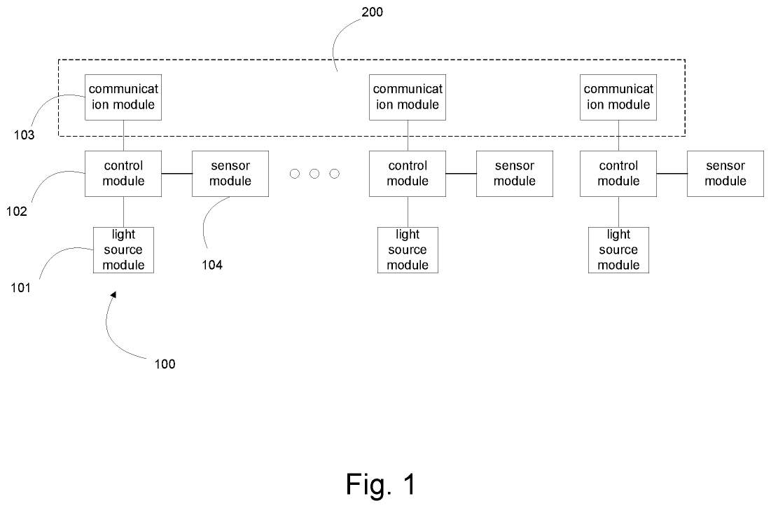

As shown in FIG. 1, the automatic lighting system of the present invention includes at least two sets of sensing lighting devices 100. In this embodiment, for the convenience of description, four sets of sensing lighting devices 100 are taken as examples. Each set of sensing lighting devices 100 in this embodiment has the same structure and composition, which includes light source module 101, control module 102, communication module 103 and sensor module 104. The light source module 101 refers to luminescent equipment, which generally refers to the lamp body, which can be kinds of electric energy luminescent equipment. In order to save energy and reduce emission, the light source module 101 in this example refers to LED lamps, which are generally equipped with a drive module, which is the prior art and will not be described here. The communication module 103 is used to receive and transmit signals, and can also use existing technologies, in this embodiment, the communication module 103 adopts Bluetooth, which has mature technology and many functions, and meets the requirements of this embodiment, the networking can use Bluetooth Mesh function.

The control module 103 is used for receiving, sending and processing signals. Currently, SCM is commonly used, and SCM is also used in this embodiment. Control module 103 can integrate the control functions of communication module 103, sensor module 104 and light source module 101 with one single chip microcomputer, or communication module 103, sensor module 104 and light source module 101 can be separately set with their own single chip microcomputer. In the prior art, communication module 103, sensor module 104 and light source module 101 are always integrated with SCM when sold. In order to facilitate manufacturing, ready-made communication module 103, sensor module 104 and light source module 101 with microcontrollers are generally purchased. In this embodiment, the Bluetooth adopted by communication module 103 has a control unit, and the specific settings can be selected according to needs. The implementation modes of control module 103 mentioned above are existing technologies without further description.

In order to realize synchronous lighting control, in this embodiment, all communication modules 101 are configured to the same communication network 200; The control module 102 controls the brightness of the respective light source module 101 according to the signals in the respective sensing module 104 or communication network 200. Through networking, the signals detected by the sensor module 104 of each sensor lighting device 100 are sent to the communication network 200 for sharing, so that sensor lighting devices 100 can realize synchronous lighting.

In addition, the automatic lighting system can be grouped in a large system. Multiple sets of devices can first form a large communication network. After forming a large communication network, they can be grouped into multiple communication networks according to the different application environment of the sensor module and each communication network corresponds to an automatic lighting system. The sensor modules between the various automatic lighting systems do not interfere with each other. Large communication network can be used to configure other parameters to simplify parameter configuration.

The sensor module 104 is used to detect people or objects entering the lighting area, as long as the above functions can be realized. In this embodiment, the sensor module 104 is a microwave sensor with high sensitivity and accuracy. PIR pyroelectric sensor, infrared sensor or ultrasonic sensor can also be used.

The lighting system of this embodiment is mainly for the lighting of the same area. The sensor lighting device 100 is installed in the same lighting area, and the embodiment realizes synchronous lighting with good lighting effect.

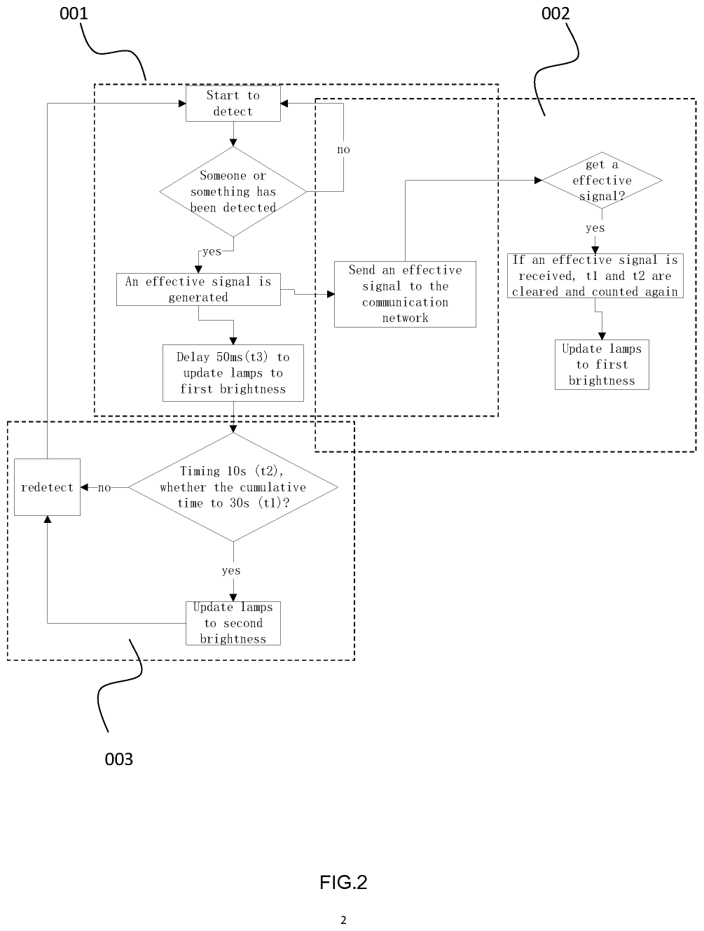

As shown in FIG. 2, the automatic lighting control method of this embodiment adopts the automatic lighting system according to the above mentioned, including the following steps:

S1: The sensor module 104 detects whether someone or something is within the detection range, if there is an effective signal, the control module 102 of the same device receives the effective signal and sends the effective signal to the communication network 200 through the communication module 103, and controls the light source module 101 of the same device according to the effective signal to maintain the first brightness;

S2: The control module 102 obtains an effective signal from the communication network 200 through the communication module 103 of the same device, and controls the light source module 101 of the same device to maintain the first brightness;

S3: When the control module 102 determines that there is no effective signal at present, the light source module 101 that controls the same device is maintained at a second brightness less than the first brightness.

In order to describe more accurately, In this embodiment, each set of sensor lighting device 100 is numbered as A, B, C and D respectively, and the sensor lighting devices 100 (A, B, C and D) in the same network are in unmanned state after power-on and initialization. At this time, the light source module 101 is in the second brightness, which can be 0 or a low brightness, such as 10% of the maximum brightness; Then someone or something is detected by A, that is, an effective signal is generated, and then A broadcasts an instruction telling BCD that it has detected someone or something, and A will turn on its load lamp to the first brightness, which can be the maximum brightness or the proportion can be set as required, as long as it is higher than the second brightness. BCD will adjust their lamps to the first brightness after receiving the instruction from A; A, B, C, and D are timed separately, and when 5 s to 20 s (t2) are recorded, as an example, a detection period of the sensor module 104 in step 001 is 10 s. all sensor modules 104 start to detect again, if B detects someone or something at this time, B sends an instruction to ACD. ABCD all clear their respective timing value; When the timing reaches more than 20 s to 50 s (t1) and no person or object is detected by all devices, it is considered that no one is present, and the sensor lighting device 100 reduces the brightness to the second brightness respectively. as an example, the control module 102 determines that there is no current effective signal under the following condition: the control module 102 has not received an effective signal after 30 s.

The method of this embodiment is simple to install and there is no need to calibrate each sensor module 104. And It runs automatically after being powered on, not only to achieve the effect of automatic energy saving and avoid the asynchronous phenomenon between each other. The automatic lighting system is suitable for multiple sets of devices in the same public area: In the application system, since each sensor lighting device 100 has a light controller that controls the light source module 101, the light controller is a part of the control module 102. If an independent sensing is used, the state of multiple light source modules 101 in the same area will be inconsistent (Some sense that the light is on, some don't sense that the light is off), and the mechanism adopted above avoids this phenomenon. When the device detects people, it will inform every sensor device in the network, so that all devices will unify the state and achieve the state unification.

In order to improve the synchronization of sensor lighting devices 100, in step 001, the control module 102 controls the light source module 101 of the same device to maintain at the first brightness according to the effective signal delay of 30 ms˜100 ms. That is, when the control module 102 receives the effective signal detected by the sensor module 104 of the same device, the brightness of the same device will be adjusted 30 ms˜100 ms (t3) later, so as to adjust the brightness synchronously with other devices receiving effective signals from the network. As an example, the control module 102 controls the light source module 101 of the same device to maintain at the first brightness according to the effective signal delay of 50 ms.

To balance efficiency and power consumption, the detection period of the sensor module 104 in step 001 is 5 s to 20 s. Further, in step 003, the control module 102 determines that there is no current effective signal under the following conditions: the control module 102 has not received a effective signal after 20 s to 50 s.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. An automatic lighting system, comprising at least two sets of sensing lighting devices (100), which comprises a light source module (101), a control module (102), communication modules (103) and sensor modules (104), characterized in that, all communication modules (101) are configured to the same communication network (200); and the control module (102) controls the brightness of the respective light source module (101) according to signals in the respective sensor module (104) or communication network (200).

2. The automatic lighting system as claimed in claim 1, wherein the communication module (103) uses Bluetooth.

3. The automatic lighting system as claimed in claim 1, wherein the sensor module (104) is a microwave sensor.

4. The automatic lighting system as claimed in claim 1, wherein the sensing lighting devices (100) are installed in the same illumination area.

5. An automatic lighting control method, the automatic lighting system as claimed in claim 1, comprising the following steps:
S1: the sensor module (104) detects whether someone or something is within the detection range, if there is an effective signal, the control module (102) of the same device receives the effective signal and sends the effective signal to the communication network (200) through the communication module (103), and controls the light source module (101) of the same device according to the effective signal to maintain the first brightness;
S2: the control module (102) obtains an effective signal from the communication network (200) through the communication module (103) of the same device, and controls the light source module (101) of the same device to maintain the first brightness;
S3: when the control module (102) determines that there is no effective signal at present, the light source module (101) that controls the same device is maintained at a second brightness less than the first brightness.

6. The automatic lighting control method as claimed in claim 5, wherein in step 001, the control module (102) controls the light source module (101) of the same device to maintain at the first brightness according to the effective signal delay of 30 ms˜100 ms.

7. The automatic lighting control method as claimed in claim 5, wherein a detection period of the sensor module (104) in step 001 is 5 s to 20 s.

8. The automatic lighting control method as claimed in claim 5, wherein in step 003, the control module (102) determines that there is no current effective signal under the following condition: the control module (102) has not received an effective signal after 20 s to 50 s.

9. The automatic lighting control method as claimed in claim 6, wherein in step 001, the control module (102) controls the light source module (101) of the same device to maintain at the first brightness according to the effective signal delay of 50 ms.

10. The automatic lighting control method as claimed in claim 7, wherein a detection period of the sensor module (104) in step 001 is 10 s.

11. The automatic lighting control method as claimed in claim 8, wherein in step 003, the control module (102) determines that there is no current effective signal under the following condition: the control module (102) has not received an effective signal after 30 s.
